(19) United States
(12) Patent Application Publication
(10) Pub. No.: US 2013/0286005 A1
(43) Pub. Date: Oct. 31, 2013

(54) Three-Dimensional Display Device and Drive Method Thereof

(71) Applicants: Qiaosheng Liao, Shenzhen (CN); Chia-chiang Hsiao, Shenzhen (CN); Chih-Wen Chen, Shenzhen (CN)

(72) Inventors: Qiaosheng Liao, Shenzhen (CN); Chia-chiang Hsiao, Shenzhen (CN); Chih-Wen Chen, Shenzhen (CN)

(73) Assignee: SHENZHEN CHINA STAR OPTOELECTRONICS TECHNOLOGY CO. LTD., Shenzhen (CN)

(21) Appl. No.: 13/510,955

(22) PCT Filed: May 3, 2012
(86) PCT No.: PCT/CN12/75020

§ 371 Date: May 21, 2012

(30) Foreign Application Priority Data
Apr. 27, 2012 (CN) 201210129127.4

(51) Int. Cl. G06T 15/00

(52) U.S. Cl. 345/419

(57) ABSTRACT

The present invention provides a three-dimensional display device and drive method thereof. The three-dimensional display device comprises: a plurality of pixels arranged in matrix, gate driver and source driver; wherein the source driver supplies a constant drive voltage to keep the fourth sub-pixel area stay in dark state during the scanning. In this manner, the effect of the technique is equivalent to increasing the width of the black matrix without sacrificing the aperture ratio so as to improve the vertical view angle of the three-dimensional display device.

### BACKGROUND OF THE INVENTION

1. Field of the Invention

The present invention relates to the field of three-dimensional (3D) displaying techniques, and in particular to a three-dimensional display device and drive method thereof.

2. The Related Arts

The contemporary three-dimensional (3D) display device usually employs parallel approach to realize three-dimensional display. The basic operation theory is to dispose a retarder at the light emitting direction of the display panel. By using the different areas of the retarder to obtain different phase retardations and resulting in the light of different pixels emitting in different polarization direction, the viewer wearing polarized glass can observe three-dimensional images.

However, because the contemporary three-dimensional display device suffers the crosstalk problem between the left-eye image and the right-eye image, the three-dimensional display device has the shortcoming of narrow vertical view angle. The known techniques increase the width of black matrix (BM) to increase the vertical view angle of the three-dimensional display device. But, this technique will lead to the decrease of aperture ratio and degradation in display quality.

Thus, it is desired to have a three-dimensional display device and drive method thereof to overcome the above problems.

### SUMMARY OF THE INVENTION

The technical issue to be addressed by the present invention is to provide a three-dimensional display device and drive method thereof, which makes the fourth sub-pixel area to stay in dark state so as to improve the vertical view angle of the three-dimensional display device.

An embodiment of the present invention provides a drive method of three-dimensional display device, applicable to a three-dimensional display device having a plurality of pixel units arranged in matrix, with each pixel unit comprising a first sub-pixel area, a second sub-pixel area, a third sub-pixel area, and a fourth sub-pixel area; a gate driver, for supplying a scan voltage to the plurality of sub-pixel areas; a source driver, for supplying a drive voltage to the plurality of sub-pixel areas. The drive method comprises: scanning the first sub-pixel area, the second sub-pixel area, the third sub-pixel area, and the fourth sub-pixel area sequentially; during scanning the fourth sub-pixel area, the source driver supplying a constant drive voltage to keep the fourth sub-pixel area to stay in the dark state during the scanning, wherein the drive voltage equal to the common voltage of the three-dimensional display device; the first sub-pixel area, the second sub-pixel area, the third sub-pixel area, and the fourth sub-pixel area being the red sub-pixel area, the green sub-pixel area, the blue sub-pixel area, and the white or yellow sub-pixel area, respectively.

Another embodiment of the present invention provides a three-dimensional display device, which comprises: a plurality of pixel units arranged in matrix, with each of pixel units comprising a first sub-pixel area, a second sub-pixel area, a third sub-pixel area, and a fourth sub-pixel area; a gate driver, for supplying a scan voltage to the plurality of sub-pixel areas to scan the first sub-pixel area, the second sub-pixel area, the third sub-pixel area, and the fourth sub-pixel area sequentially; a source driver, for supplying a drive voltage to the plurality of sub-pixel areas; wherein during scanning the fourth sub-pixel area, the source driver supplying a constant drive voltage to keep the fourth sub-pixel area to stay in the dark state during the scanning.

According to the embodiment of the present invention, wherein each of the pixel units comprises: four sub-pixel electrodes disposed on first substrate, four color resistance areas disposed on second substrate and black matrixes disposed two adjacent color resist areas; wherein the first color resist area and the first sub-pixel are disposed correspondingly to form the first sub-pixel area; the second color resist area and the second sub-pixel are disposed correspondingly to form the second sub-pixel area; the third color resist area and the third sub-pixel are disposed correspondingly to form the third sub-pixel area; and the fourth color resist area and the fourth sub-pixel are disposed correspondingly to form the fourth sub-pixel area.

According to the embodiment of the present invention, wherein each of the pixel units further comprises: a data line disposed on first substrate, four scan lines and four TFT switches; wherein scan lines being for supplying scan voltage, data line for transmitting drive voltage; the gate terminal of the first TFT switch connected to the first scan line, the source terminal of the first TFT switch connected to the data line and the drain terminal of the first TFT switch connected to first pixel electrode; the gate terminal of the second TFT switch connected to the second scan line, the source terminal of the second TFT switch connected to the data line and the drain terminal of the second TFT switch connected to second pixel electrode; the gate terminal of the third TFT switch connected to the third scan line, the source terminal of the third TFT switch connected to the data line and the drain terminal of the third TFT switch connected to third pixel electrode; the gate terminal of the fourth TFT switch connected to the fourth scan line, the source terminal of the fourth TFT switch connected to the data line and the drain terminal of the fourth TFT switch connected to fourth pixel electrode.

According to the embodiment of the present invention, the first sub-pixel area, the second sub-pixel area, the third sub-pixel area, and the fourth sub-pixel area are the red sub-pixel area, the green sub-pixel area, the blue sub-pixel area, and the white or yellow sub-pixel area, respectively.

According to the embodiment of the present invention, the drive voltage is equal to the common voltage of the three-dimensional display device.

Another embodiment of the present invention provides a drive method of three-dimensional display device, applicable to a three-dimensional display device having a plurality of pixel units arranged in matrix, with each pixel unit comprising a first sub-pixel area, a second sub-pixel area, a third sub-pixel area, and a fourth sub-pixel area; a gate driver, for supplying a scan voltage to the plurality of sub-pixel areas; a source driver, for supplying a drive voltage to the plurality of sub-pixel areas. The drive method comprises: scanning the first sub-pixel area, the second sub-pixel area, the third sub-pixel area, and the fourth sub-pixel area sequentially; wherein during scanning the fourth sub-pixel area, the source driver supplying a constant drive voltage to keep the fourth sub-pixel area to stay in the dark state during the scanning.

According to the embodiment of the present invention, wherein each of the pixel units comprises: four sub-pixel electrodes disposed on first substrate, four color resistance areas disposed on second substrate and black matrixes disposed two adjacent color resist areas; wherein the first color resist area and the first sub-pixel are disposed correspondingly to form the first sub-pixel area; the second color resist area and the second sub-pixel are disposed correspondingly to form the second sub-pixel area; the third color resist area and the third sub-pixel are disposed correspondingly to form the third sub-pixel area; and the fourth color resist area and the fourth sub-pixel are disposed correspondingly to form the fourth sub-pixel area.

According to the embodiment of the present invention, wherein each of the pixel units further comprises: a data line disposed on first substrate, four scan lines and four TFT switches; wherein scan lines being for supplying scan voltage, data line for transmitting drive voltage; the gate terminal of the first TFT switch connected to the first scan line, the source terminal of the first TFT switch connected to the data line and the drain terminal of the first TFT switch connected to first pixel electrode; the gate terminal of the second TFT switch connected to the second scan line, the source terminal of the second TFT switch connected to the data line and the drain terminal of the second TFT switch connected to second pixel electrode; the gate terminal of the third TFT switch connected to the third scan line, the source terminal of the third TFT switch connected to the data line and the drain terminal of the third TFT switch connected to third pixel electrode; the gate terminal of the fourth TFT switch connected to the fourth scan line, the source terminal of the fourth TFT switch connected to the data line and the drain terminal of the fourth TFT switch connected to fourth pixel electrode.

According to the embodiment of the present invention, the first sub-pixel area, the second sub-pixel area, the third sub-pixel area, and the fourth sub-pixel area are the red sub-pixel area, the green sub-pixel area, the blue sub-pixel area, and the white or yellow sub-pixel area, respectively.

According to the embodiment of the present invention, the drive voltage is equal to the common voltage of the three-dimensional display device.

The efficacy of the present invention is that to be distinguished from the state of the art. The three-dimensional display device and drive method thereof, by supplying constant drive voltage to keep the fourth sub-pixel area stay in dart state during scanning, is equivalent to increasing the width of black matrix. Without sacrificing the aperture ration, the present invention increases the vertical view angle of the three-dimensional display device so as to increase the view range of the three-dimensional display device to improve the view experience.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a three-dimensional display device of the present invention;

FIG. 2 is a schematic view showing the structure of display panel of three-dimensional display device of the present invention;

FIG. 3 is a side view showing the structure of display panel of FIG. 2;

FIG. 4 is schematic view showing the structure of the first substrate of FIG. 3;

FIG. 5 is flowchart of the drive method of the three-dimensional display device of the present invention; and

FIG. 6 is a schematic view showing the drive effect of the drive method of the three-dimensional display device of the present invention.

### DETAILED DESCRIPTION OF THE PREFERRED EMBODIMENTS

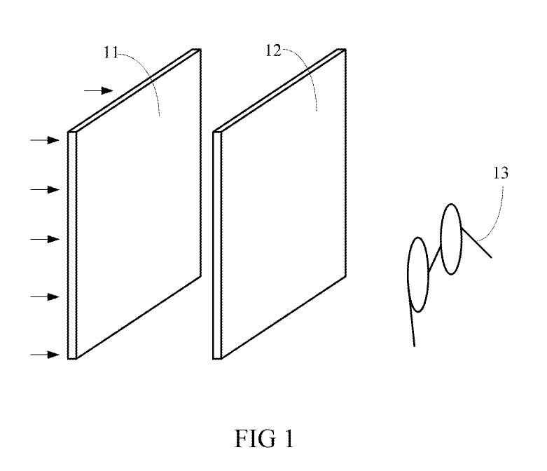

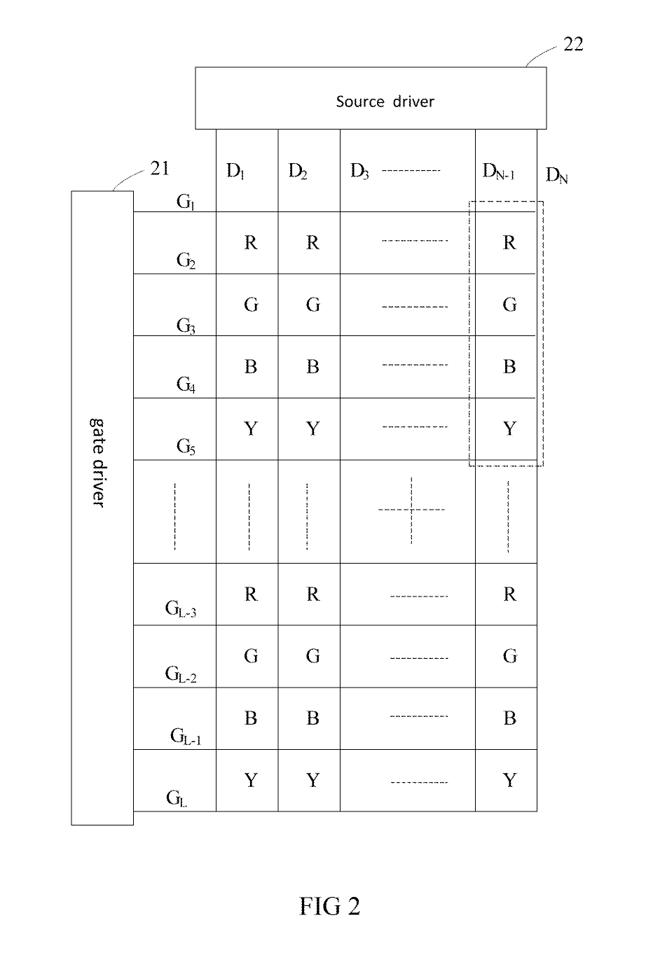

Referring to FIG. 1, FIG. 1 is a schematic view illustrating the structure of a preferred embodiment of three-dimensional display device according to the present invention. FIG. 2 is a schematic view showing the structure of display panel of three-dimensional display device according to the present invention. As shown in FIG. 1, the three-dimensional display device of the present invention comprises a display panel 11 and a retarder 12.

In the present invention, retarder 12 is disposed on the light-emitting side of display panel 11, in parallel with display panel 11 and with a gap from display panel 11. It is worth noting that the three-dimensional display device is applicable to viewer wearing glasses 13 having two polarized lenses with orthogonal polarization.

According to the present embodiment, display panel 11 can be a tri-gate pixel structure arranged in rows or columns, wherein in the row orientation, the sub-pixels are arranged in rows, while the sub-pixels are arranged in columns in the column orientation.

In comparison with row-oriented pixel structure, the column-oriented pixel structure can reduce the number of source ICs which is costly in display panel 11 to save cost. Therefore, the column-oriented pixel structure is more commonly applied in display panel 11 in three-dimensional display device. Hence, the three-dimensional display device in the present invention uses column-oriented pixel structure as embodiment.

FIG. 2 shows a schematic view of the structure of display panel using the column-oriented pixel structure in the three-dimensional display device according to the present invention.

As shown in FIG. 2, display panel 11 comprises a plurality of pixel units arranged in matrix, a plurality of data lines D₁, D₂, . . . , D_{N} disposed in parallel with separating gaps, and a plurality of scan lines G₁, G₂, . . . , G_{L} disposed perpendicularly to data lines D₁, D₂, . . . , D_{N}.

According to the present embodiment, as shown by the dash line in FIG. 2, each of pixel units comprises four sub-pixel units, i.e., R sub-pixel unit, G sub-pixel unit, B sub-pixel unit, and Y sub-pixel unit, electrically connected to the same data line in sequential order.

The plurality of scan lines G₁, G₂, . . . , G_{L} are connected to gate driver 21. Gate driver 21 is to supply a scan voltage to a plurality of R sub-pixel units, G sub-pixel units, B sub-pixel units, and Y sub-pixel units.

The plurality of data lines D₁, D₂, . . . , D_{N} are connected to source driver 22. Source driver 22 is to supply a drive voltage to a plurality of R sub-pixel units, G sub-pixel units, B sub-pixel units, and Y sub-pixel units.

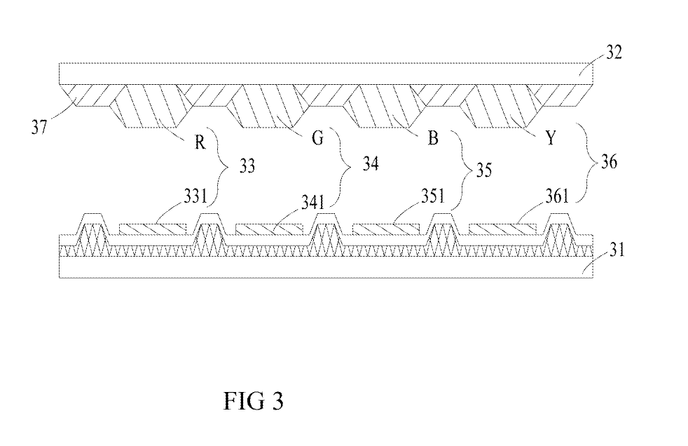

Referring to FIG. 3, FIG. 3 is a schematic side view of display panel 11 of FIG. 2. In the present invention, each of pixel units in display panel 11 has the similar structure. The following description is based on a pixel unit.

As shown in FIG. 3, display panel 11 comprises: a first substrate 31 and a second substrate 32 disposed opposing each other, and a liquid crystal layer (not shown) sandwiched between first substrate 31 and second substrate 32.

In the present embodiment, each of pixel units in display panel 11 comprises: four sub-pixel electrodes 331, 341, 351, 361 disposed on first substrate 31, four color resist areas, i.e., red (R), green (G), blue (B) and yellow (Y), disposed on second substrate 32, and black matrixes disposed between two adjacent color resist areas.

According to the present embodiment, first color resist area R and first sub-pixel electrode 331 are disposed correspondingly to form first sub-pixel area 33; second color resist area G and second sub-pixel 341 are disposed correspondingly to form second sub-pixel area 34; third color resist area B and third sub-pixel 351 are disposed correspondingly to form third sub-pixel area 35; and fourth color resist area Y and fourth sub-pixel 361 are disposed correspondingly to form fourth sub-pixel area 36.

In addition, a black matrix 37 is disposed between first sub-pixel area 33 and second sub-pixel area 34, between second sub-pixel area 34 and third sub-pixel area 35, between third sub-pixel area 35 and fourth sub-pixel area 36, as well as, between two adjacent pixel units.

It is worth noting that in the present embodiment, first sub-pixel area 33 is red sub-pixel area, second sub-pixel area 34 is green sub-pixel area, third sub-pixel area 35 is blue sub-pixel area, and fourth sub-pixel area 36 is yellow sub-pixel area. But in another embodiment, fourth sub-pixel area 36 can be realized as a white sub-pixel area.

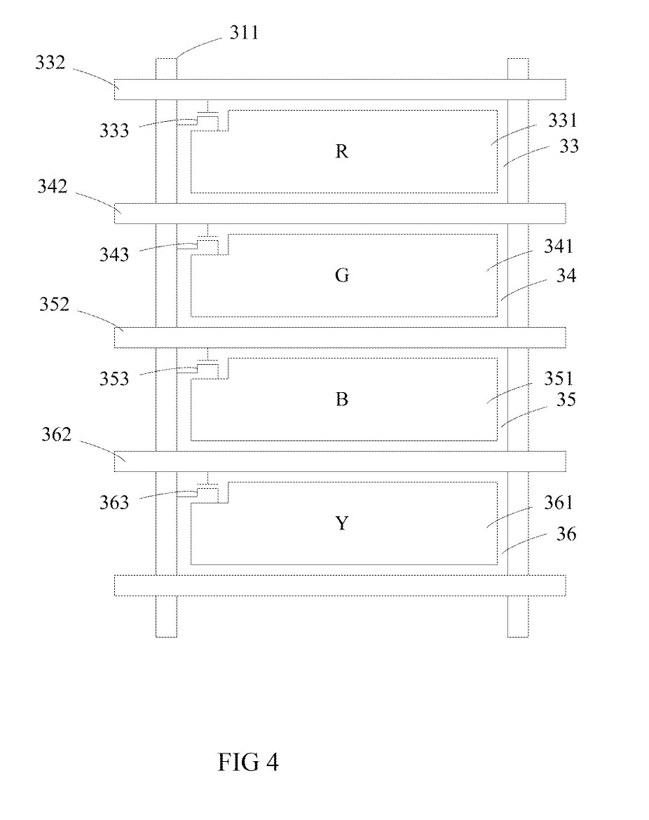

FIG. 4 shows a schematic view of first substrate 31 of FIG. 3. As shown in FIG. 4, in the present embodiment, first substrate 31 is disposed with data line 311, first scan line 332, second scan line 342, third scan line 352, fourth scan line 362, first TFT switch 333, second TFT switch 343, third TFT switch 353 and fourth TFT switch 363.

According to the present embodiment, the gate terminal of first TFT switch 333 is connected to gate driver 21 through first scan line 332, and the drain terminal of first TFT switch 333 is connected to first sub-pixel electrode 331.

The gate terminal of second TFT switch 343 is connected to gate driver 21 through second scan line 342, and the drain terminal of second TFT switch 343 is connected to second sub-pixel electrode 341.

The gate terminal of third TFT switch 353 is connected to gate driver 21 through third scan line 352, and the drain terminal of third TFT switch 353 is connected to third sub-pixel electrode 351.

The gate terminal of fourth TFT switch 363 is connected to gate driver 21 through fourth scan line 362, and the drain terminal of fourth TFT switch 363 is connected to fourth sub-pixel electrode 361.

The source terminal of first TFT switch 333, the source terminal of second TFT switch 343, the source terminal of third TFT switch 353 and the source terminal of fourth TFT switch 363 are all connected to source driver 22 through data line 311.

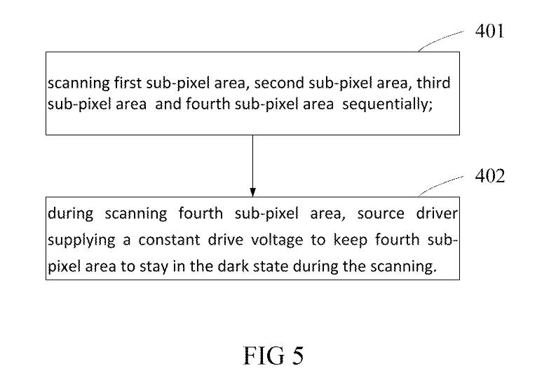

FIG. 5 shows a flowchart of the drive method of three-dimensional display device of the present invention. As shown in FIG. 5, the method of three-dimensional display device of the present invention comprises the steps of:

Step S401: scanning first sub-pixel area 33, second sub-pixel area 34, third sub-pixel area 35 and fourth sub-pixel area 36 sequentially;

Step S402: during scanning fourth sub-pixel area 36, source driver 22 supplying a constant drive voltage to keep fourth sub-pixel area 36 to stay in the dark state during the scanning.

Specifically, in the present embodiment, after display panel 11 switches from two-dimensional (2D) display mode to three-dimensional display mode, when gate driver 21 supplies scan voltage through fourth scan line 362 to gate terminal of fourth TFT switch 363, fourth TFT switch becomes conductive and source driver 22 supplies constant voltage to fourth sub-pixel electrode 361 so that fourth sub-pixel area 36 stays in the dark state during the scanning, while first sub-pixel area 33, second sub-pixel area 34 and third sub-pixel area 35 output optical signal.

According to the present embodiment, the constant voltage supplied by source driver 22 to fourth sub-pixel electrode 361 is preferred to be equal to the common voltage of the three-dimensional display device.

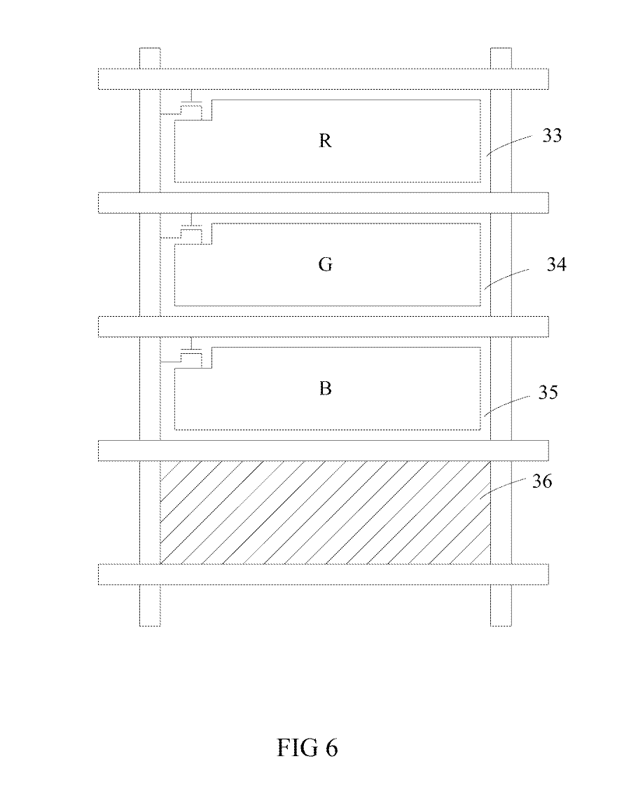

Referring to FIG. 6, FIG. 6 is a schematic view showing the drive effect of the drive method of the three-dimensional display device of the present invention.

As shown in FIG. 6, after adopting the drive method of three-dimensional display device to switch from two-dimensional (2D) display mode to three-dimensional display mode, first sub-pixel area 33, second sub-pixel area 34 and third sub-pixel area 35 output optical signal and fourth sub-pixel area 36 stays in the dark state during the scanning.

According to the known drive method, after switching from two-dimensional (2D) display mode to three-dimensional display mode, first sub-pixel area 33, second sub-pixel area 34, third sub-pixel area 35, and fourth sub-pixel area 36 output optical signal.

In summary, compared with the known drive method, in the present invention, the fourth sub-pixel area staying in the dark state during the scanning is equivalent to increasing the width of the black matrix. Therefore, without sacrificing the aperture ration, the present invention increases the vertical view angle of the three-dimensional display device so as to increase the view range of the three-dimensional display device to improve the view experience.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A drive method of three-dimensional display device, applicable to a three-dimensional display device comprising a plurality of pixel units arranged in matrix, with each of pixel units having a first sub-pixel area, a second sub-pixel area, a third sub-pixel area, a fourth sub-pixel area;
a gate driver, for supplying scan voltage to the plurality of sub-pixel areas;
a source driver, for supplying drive voltage to the plurality of sub-pixel areas;
the method comprises:
scanning the first sub-pixel electrode, the second sub-pixel area, the third sub-pixel area, and the fourth sub-pixel area sequentially;
during scanning the fourth sub-pixel area, the source driver supplying a constant drive voltage to keep the fourth sub-pixel area to say in dark state during the scanning; wherein the constant voltage being equal to common voltage of the three-dimensional display device; sub-pixel electrode, the second sub-pixel area, the third sub-pixel area being red sub-pixel area, green sub-pixel area and blue sub-pixel area, respectively; and the fourth sub-pixel area being white sub-pixel area or yellow sub-pixel area.

2. A three-dimensional display device, which comprises:
a plurality of pixel units arranged in matrix, with each of pixel units comprising a first sub-pixel area, a second sub-pixel area, a third sub-pixel area, and a fourth sub-pixel area;
a gate driver, for supplying a scan voltage to the plurality of sub-pixel areas to scan the first sub-pixel area, the second sub-pixel area, the third sub-pixel area, and the fourth sub-pixel area sequentially;
a source driver, for supplying a drive voltage to the plurality of sub-pixel areas; wherein during scanning the fourth sub-pixel area,
wherein the source driver supplying a constant drive voltage to keep the fourth sub-pixel area to stay in the dark state during the scanning.

3. The three-dimensional display device as claimed in claim 2, wherein each of pixel units further comprises:
four sub-pixel electrodes disposed on a first substrate; and
four color resistance areas disposed on second substrate and black matrixes disposed two adjacent color resist areas;
wherein the first color resist area and the first sub-pixel being disposed correspondingly to form the first sub-pixel area;
the second color resist area and the second sub-pixel being disposed correspondingly to form the second sub-pixel area;
the third color resist area and the third sub-pixel being disposed correspondingly to form the third sub-pixel area; and
the fourth color resist area and the fourth sub-pixel being disposed correspondingly to form the fourth sub-pixel area.

4. The three-dimensional display device as claimed in claim 3, wherein each of pixel units further comprises:
a data line disposed on first substrate, four scan lines and four TFT switches;
wherein the scan lines being for supplying scan voltage, the data line for transmitting drive voltage;
the gate terminal of the first TFT switch connected to the first scan line, the source terminal of the first TFT switch connected to the data line and the drain terminal of the first TFT switch connected to first pixel electrode;
the gate terminal of the second TFT switch connected to the second scan line, the source terminal of the second TFT switch connected to the data line and the drain terminal of the second TFT switch connected to second pixel electrode;
the gate terminal of the third TFT switch connected to the third scan line, the source terminal of the third TFT switch connected to the data line and the drain terminal of the third TFT switch connected to third pixel electrode;
the gate terminal of the fourth TFT switch connected to the fourth scan line, the source terminal of the fourth TFT switch connected to the data line and the drain terminal of the fourth TFT switch connected to fourth pixel electrode.

5. The three-dimensional display device as claimed in claim 2, wherein the first sub-pixel area, the second sub-pixel area, the third sub-pixel area, are the red sub-pixel area, the green sub-pixel area, the blue sub-pixel area, respectively, and the fourth sub-pixel area is the white or yellow sub-pixel area.

6. The three-dimensional display device as claimed in claim 2, wherein the drive voltage is equal to common voltage of the three-dimensional display device.

7. A drive method of three-dimensional display device, applicable to a three-dimensional display device comprising a plurality of pixel units arranged in matrix, with each of pixel units having a first sub-pixel area, a second sub-pixel area, a third sub-pixel area, a fourth sub-pixel area;
a gate driver, for supplying scan voltage to the plurality of sub-pixel areas;
a source driver, for supplying drive voltage to the plurality of sub-pixel areas;
the method comprises:
scanning the first sub-pixel electrode, the second sub-pixel area, the third sub-pixel area, and the fourth sub-pixel area sequentially;
during scanning the fourth sub-pixel area, the source driver supplying a constant drive voltage to keep the fourth sub-pixel area to say in dark state during the scanning.

8. The drive method as claimed in claim 7, wherein each of the pixel units comprises:
four sub-pixel electrodes disposed on first substrate; and
four color resistance areas disposed on second substrate and black matrixes disposed two adjacent color resist areas;
wherein the first color resist area and the first sub-pixel being disposed correspondingly to form the first sub-pixel area;
the second color resist area and the second sub-pixel being disposed correspondingly to form the second sub-pixel area;
the third color resist area and the third sub-pixel being disposed correspondingly to form the third sub-pixel area; and
the fourth color resist area and the fourth sub-pixel being disposed correspondingly to form the fourth sub-pixel area.
during scanning the fourth sub-pixel area, the source driver supplying a constant drive voltage to keep the fourth sub-pixel area to say in dark state during the scanning.

9. The drive method as claimed in claim 8, wherein each of pixel units further comprises:
a data line disposed on first substrate, four scan lines and four TFT switches;
wherein the scan lines being for supplying scan voltage, the data line for transmitting drive voltage;
the gate terminal of the first TFT switch connected to the first scan line, the source terminal of the first TFT switch connected to the data line and the drain terminal of the first TFT switch connected to first pixel electrode;
the gate terminal of the second TFT switch connected to the second scan line, the source terminal of the second TFT switch connected to the data line and the drain terminal of the second TFT switch connected to second pixel electrode;
the gate terminal of the third TFT switch connected to the third scan line, the source terminal of the third TFT switch connected to the data line and the drain terminal of the third TFT switch connected to third pixel electrode;
the gate terminal of the fourth TFT switch connected to the fourth scan line, the source terminal of the fourth TFT switch connected to the data line and the drain terminal of the fourth TFT switch connected to fourth pixel electrode.

10. The drive method as claimed in claim 7, wherein the first sub-pixel area, the second sub-pixel area, the third sub-pixel area, are the red sub-pixel area, the green sub-pixel area, the blue sub-pixel area, respectively, and the fourth sub-pixel area is the white or yellow sub-pixel area.

11. The drive method as claimed in claim 7, wherein the drive voltage is equal to common voltage of the three-dimensional display device.
